(19) United States
(12) Patent Application Publication
(10) Pub. No.: US 2010/0206796 A1
(43) Pub. Date: Aug. 19, 2010

(54) FILTER DEVICE FOR FLUIDS, PARTICULARLY HYDRAULIC FLUIDS, LUBRICATING OILS, AND FUELS

(76) Inventors: Viktor Josef Lauer, Nalbach (DE); Daniel Kleemann, Saarbrucken (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/452,904

(22) PCT Filed: Jul. 24, 2008
(86) PCT No.: PCT/EP2008/006087

§ 371 Date: Mar. 12, 2010

(30) Foreign Application Priority Data
Aug. 5, 2007 (DE) 102007037462.5

(51) Int. Cl. B01D 29/58; B01D 35/30

(52) U.S. Cl. 210/232; 210/335; 210/338

(57) ABSTRACT

The invention relates to a filter device for fluids, particularly hydraulic or lubricating oils, having a filter element (1) comprising at least one inflow region (5) for a fluid to be cleaned, characterized in that an adapter element (7) covering the inflow region (5) and forming a trap device for organic substances such as fatty particles and colloidal oil aging products may be attached to the filter element (1).

The invention relates to a filter device for fluids, particularly hydraulic fluids, lubricating oils, and fuels, with at least one filter element which has an inflow region for the fluid to be cleaned.

Both with respect to operating reliability and also for economic reasons, in the operation of mechanical systems of different types, in particular for higher-grade systems, regular detection of the machine condition is carried out in order to implement “condition-oriented maintenance”. This concept replaces the previously conventional “preventive” maintenance in which at fixed time intervals the pertinent machines were shut down and the components checked or replaced. This type of machine maintenance often led to intact components being replaced and the existing “remaining operating time” thus being wasted.

To avoid these disadvantages, current condition monitoring is done. It is prior art to carry out instantaneous recording of the condition of the oil in a system, the sensor data which characterize the cleanliness of the oil being analyzed in real time in order to determine a disruption factor which may be present. To monitor the cleanliness of the oil, optical sensors are used in the form of particle counters which detect particles or incompletely dissolved organic substances in the pertinent fluid, for example oil ageing substances, based on their phase boundary, and which reproduce the number of particles and the size distribution at regular time intervals. However, such sensors do not enable differentiation of the particle type and therefore any conclusions regarding what type of solids or incompletely dissolved substances is present.

In the assembly departments of industrial businesses many components are lubricated with greases before or during assembly. In the assembly of mechanical or hydraulic components, these greases can be used as supplementary assembly pastes or as an emergency lubricant in run-in processes, for example, in hydraulic pumps and hydraulic motors which are being run in on test benches, or in mechanical gearing, in particular planetary gearing of wind turbines, or can also improve the run-in lubrication properties of the pertinent lubricating oil. These greases, however, after installation and start-up of the pertinent systems reach the oil circuit and are then present there as finely dispersed grease particles. These grease particles are admittedly not harmful with respect to the operating or lubricating properties of the pertinent oil, but like other types of solid fouling they are detected by the optical sensors and also counted as solid fouling. In fact, corruption of the oil cleanliness measurements thus occurs; this leads to the oil being nominally classified in a cleanliness class (ISO 4406) which no longer corresponds to the pertinent specification so that countermeasures are unnecessarily taken, for example filter elements located in the system are replaced. A similarly disruptive effect on the oil cleanliness measurement is exercised by solid-containing lubricants and organic assembly aids such as lubricating pastes, anticorrosion agents, cements or sealants. Another group of problems is oil ageing products which are formed under the extreme loading of the lubricating oil in high performance gearing, for example in wind turbines. Under special conditions colloidal ageing products originate from the additives which are originally present dissolved. These substances are not harmful with respect to the operating and lubricating properties of the pertinent fluid, but, just like other types of solid fouling, they are also counted. This likewise causes corruption of the oil cleanliness measurement.

With respect to these problems, the object of the invention is to make available a filter device which, in conjunction with systems in which the condition of the oil is monitored, avoids the danger of an erroneous assessment of condition.

According to the invention this object is achieved by a filter device which has the features of claim 1 in its entirety.

Accordingly, the essential peculiarity of the invention consists in that upstream from the inflow region of the filter element an adapter element is connected which forms a trap device for those particles which could lead to an erroneous assessment of the condition of the fluid if these particles were also counted by a particle counter positioned downstream from the filter element. This ensures that the particle counter result determined at the time enables proper assessment of the condition of the oil.

In devices in which the filter element, in the generally conventional manner, is a body which defines a longitudinal axis whose outer surface which surrounds the longitudinal axis forms the inflow region, the arrangement is preferably made such that the adapter element has the shape of a trap device for these particles which covers this outer surface. As required, this jacket-shaped trap device, i.e., after it has picked up the components which are present as particles distributed in a finely dispersed manner in the oil circuit and which have been detached from system parts, can be removed and optionally replaced by a new jacket without the filter element itself having to be dismounted or replaced.

This process is especially fast and easy when the jacket is formed from a web of filter material whose opposite ends can be brought together to form the jacket shape and can be connected to one another via a jacket closure which runs in the longitudinal direction. This jacket can be especially easily removed after the closure is opened. Attachment to the filter element is likewise easy and convenient by the web of filter material being placed around the filter element, i.e., in particular, being brought into the shape of a hollow cylinder, and being applied to the outer surface of the filter element which is circularly cylindrical in the corresponding case before the jacket closure is closed.

In especially advantageous embodiments the closure can be formed by an adhesive connection.

A filter mat web of a nonwoven with a coarse pore structure has proven especially suitable for the formation of the trap device.

In advantageous exemplary embodiments the nonwoven is made of a lipophilic material, in particular fibers of polyolefin or polyester with co-polyesters. Nonwovens of other types of nonpolar organic substances can likewise be used.

In especially advantageous exemplary embodiments, the arrangement is made such that the web of filter material formed from the nonwoven has a cross-linked, voluminous fiber structure with coarser filter fineness than the downstream filter element or the downstream filter layer.

In exemplary embodiments in which the filter element, according to one popular design on each of its ends which are opposite one another in the longitudinal direction, has a cover element which forms the ends of the inflow region, there is preferably a fixing device which interacts with the cover elements for the respective end edge of the trap device.

According to claim 10, the subject matter of the invention is also an adapter element for a filter device according to one of claims 1 to 9, the adapter element having a coarse-pored nonwoven which can be attached to the assigned filter element as a prefilter stage which covers its inflow region.

The invention is detailed below using the drawings.

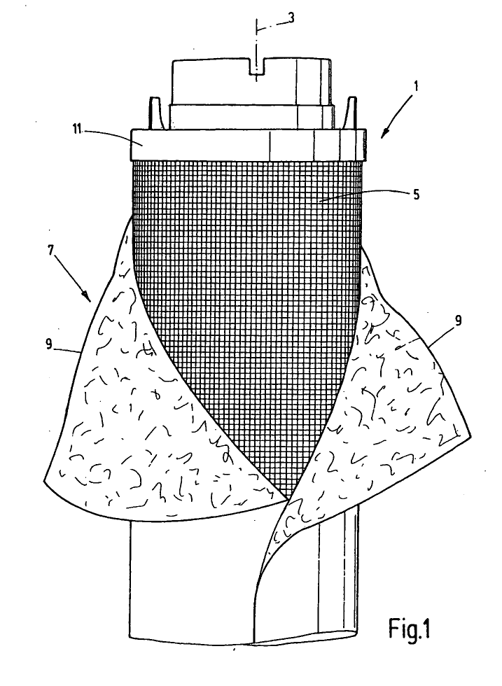

FIG. 1 shows a perspective partial side view of one embodiment of the filter device according to the invention, a trap device which is located on the filter element being shown in the partially opened state;

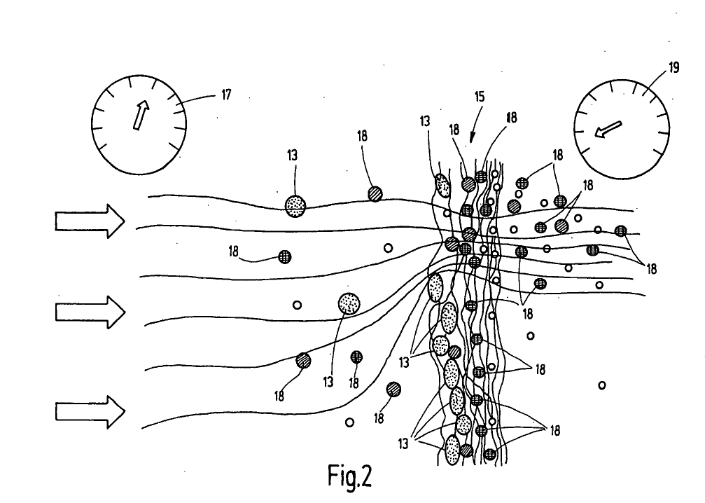

FIG. 2 shows a schematic of the deposition processes on a filter element through which a fluid flows which is burdened with organic substances and oil ageing products;

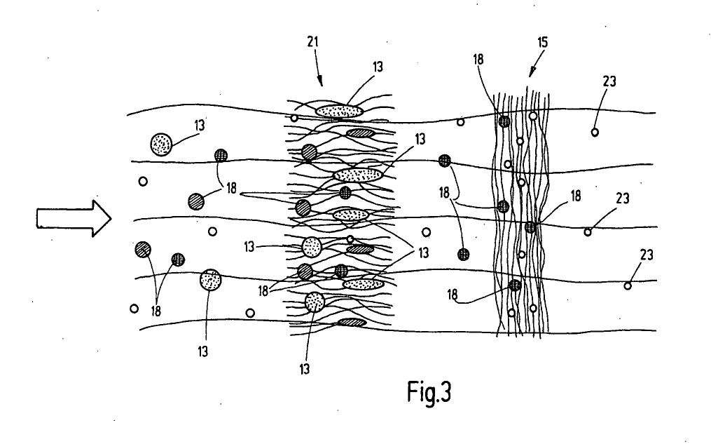

FIG. 3 shows a schematic similar to FIG. 2, which for explanation of the method of operation of the invention shows deposition processes when using a nonwoven which is connected upstream from the filter element;

FIG. 4 shows a perspective oblique view of one exemplary embodiment of the filter device according to the invention, drawn roughly full scale;

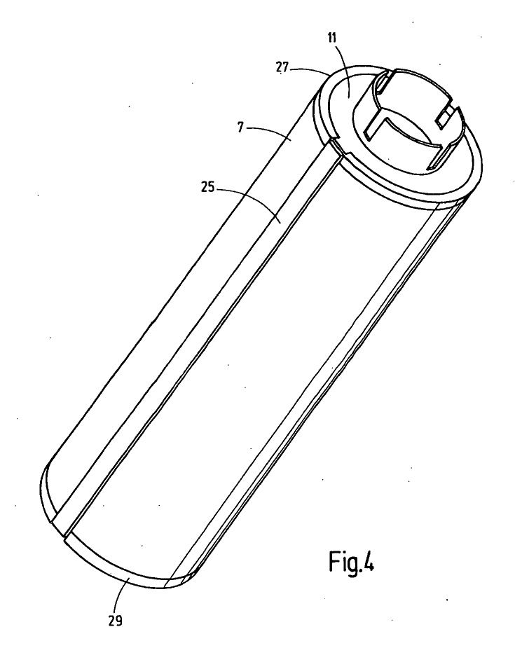

FIG. 5 shows an oblique view similar to FIG. 4, in which only the jacket with the fixing parts removed from it is shown;

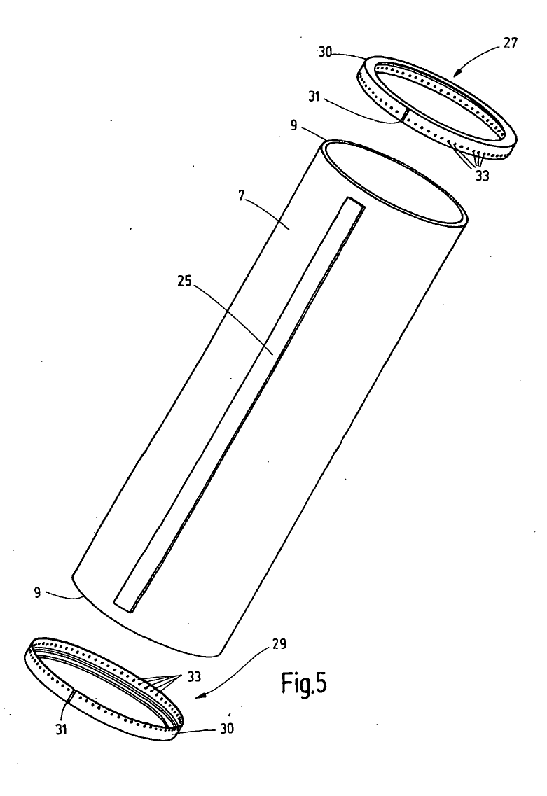

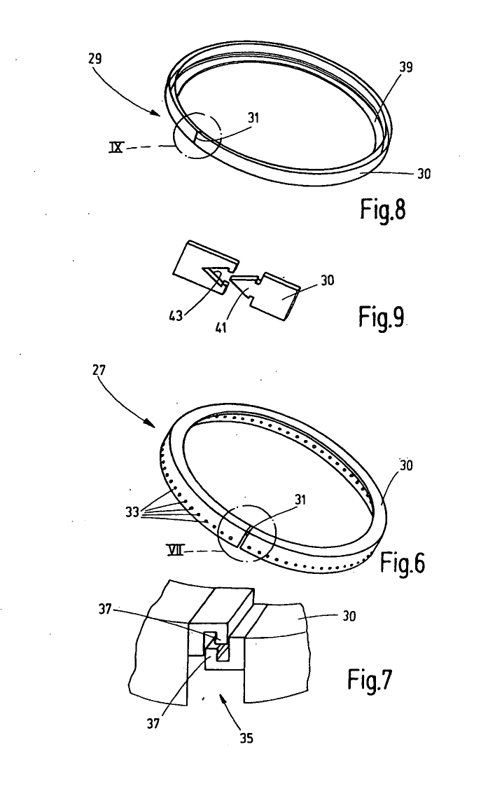

FIG. 6 shows a perspective oblique view of only one of the fixing elements shown there, drawn slightly enlarged compared to FIG. 5;

FIG. 7 shows a partial representation of only the region designated as VII in FIG. 6, greatly enlarged compared to FIG. 6;

FIG. 8 shows a representation of a fixing element of modified design, similar to FIG. 6 and

FIG. 9 shows a partial representation of only the region designated as IX in FIG. 8, drawn greatly enlarged compared to FIG. 8.

In FIG. 1 the filter element designated as a whole as 1, which, in this example, it is made as a more or less circularly cylindrical body which defines a longitudinal axis 3. The filter element 1 is a filter through which flow takes place from the outside to an inner filter cavity and which has an inner support tube which is concentric to the axis 3 and which surrounds the inner filter cavity, is provided with fluid passages, and is used as the carrier for the filter mat which surrounds the support tube. The filter mat is made zig-zag-shaped or pleated from a plurality of adjoining filter webs, from the inside to the outside a metal gauze or plastic lattice/gauze or a high-grade steel-polyester mixed gauze, an overlying paper nonwoven or polyester nonwoven, an overlying glass fiber mat or a melt-blown nonwoven, another such mat and an overlying polyester nonwoven being able to form the layer structure of this filter mat. FIG. 1 shows that over this filter mat is an outer perforated support body, in this example a printed outer plastic sleeve. This outer sleeve 5 forms the inflow region of the filter element, i.e., that outer surface of the filter element 1 via which the fluid to be cleaned enters.

FIG. 1 shows that an additional nonwoven which is designated as a whole as 7 is partially placed around the outer sleeve 5 which forms the inflow region. When the additional nonwoven 7 has been placed completely around the outer sleeve 5 and the jacket 7 has been closed, the end edge 9 which is the upper edge in FIG. 1 is fixed on the upper cover part 11 of the filter element 1. The corresponding applies to the lower end edge of the jacket 7, which edge is not visible in FIG. 1, which is fixed on the lower cover part of the filter element 1, which part is not visible in FIG. 1. The relevant details are examined below with reference to FIGS. 4 to 9.

The jacket 7 is formed from a web of filter material of a nonwoven of coarse pore structure, preferably from a lipophilic material, for example from fibers of polyolefin or of polyester with co-polyesters or other nonpolar organic materials, a cross-linked, voluminous fiber structure being formed whose fineness is coarser than that of the downstream filter element.

FIG. 2 schematically illustrates conditions on a filter element for deep filtration, through which oil flows which is burdened with grease particles 13 or organic colloids, without a trap device upstream from the filter material 15. As is apparent, settling of grease particles 13 occurs, by which the permeability of the filter material 15 is reduced. As is illustrated by the schematically suggested pressure gauge designated as 17 and 19, a major increase of the differential pressure thus occurs. This results in that at local sites of higher permeability the flow velocity is locally high, as a result of which grease particles and organic colloids 13 which have already settled beforehand in the filter material 15 and which contribute to an apparent deterioration of the condition of the oil are torn out of the filter material 15 and travel into the system so that in this operating state downstream from the filter material 15 a higher counting rate can arise than upstream from the filter material 15.

This means that the assessment of the fluid condition, when it is done based on a particle counter, does not ensure a realistic assessment of the condition of the oil because in the case in which the particles are counted upstream from the filter material 15, the grease particles or organic colloids 15 which are not relevant to the assessment of the condition would also be counted, or, for particle counting which has been undertaken downstream, a larger number of particles can be counted than is in fact present upstream from the filter material 15. A disruptive factor in addition is that clogging of the filter material 15 with grease particles or organic colloids 13 leads to a drastic increase of the differential pressure and to endangerment of the system and/or the necessity of changing the filter.

FIG. 3 illustrates conditions when there is a trap device 21 which is connected upstream from the filter material 15. Due to the large pores of the nonwoven material of the trap device 21, settling of the grease particles and organic colloids 13 occurs, but the differential pressure does not rise, nor does the flow velocity increase locally. Therefore, only the dirt particles 18 which pass through the coarse-pored material of the trap device 21 reach the filter material 15 so that the filter material 15 undertakes cleaning in normal filtration operation, as a result of which in turn downstream from the filter material 15 only a small number of remaining fine particles 23 is counted and considered for the classification of the condition of the oil.

FIG. 4 shows one exemplary embodiment of the filter device in which the trap jacket 7 which is closed with a jacket closure 25 which runs in the longitudinal direction is fixed with an upper fixing element 27 on the upper cover part 11 of the filter element and with a lower fixing element 29 on the lower cover part of the filter element, which lower part is not shown. In this example, the jacket closure 25 is formed by a touch fastener element in which a carrier strip has interlocking elements which project on one side and which directly engage the fiber structure of the nonwoven by interlocking, so that the jacket 7 can be easily closed by the ends which run in the longitudinal direction being placed next to one another and by the strip of the closure 25 being placed over the joint in order to effect engagement by interlocking.

FIGS. 5 to 9 illustrate some of a plurality of possible designs for fixing elements 27 and 29 which can be attached as an enclosure of the end edges 9 of the jacket 7 to these end edges 9 and for their part can be fixed on the cover elements 11 of the filter element 1.

FIGS. 5 and 6 show that the fixing elements 27 and 29 are open annular bodies, i.e., have a separation site 31. These annular bodies form spreadable plastic clamp rings 30 which can be clamped onto the pertinent cover part 11 of the filter element 1. In the example from FIGS. 5 to 7 these clamp rings 30 have peripheral perforations 33 (only partially numbered) by means of which these annular bodies can be joined to the end edges 9 of the jacket 7. By spreading the fixing elements 27, 29 formed by the clamp rings 30 with the attached filter material web of the jacket 7 and with the jacket closure 25 opened, the unit consisting of the clamp rings 30 and the jacket 7 can be pushed over the filter element until a position is reached in which the clamp rings 30 clamp the cover parts 11. The jacket 7 thus forms a blanket cover of the printed outer sleeve 5 on the outside of the filter element 1 which forms the inflow region.

FIG. 7 shows that the clamp ring 30 at the separation site 31 is not only kept closed by the force of its elasticity, but that, as is the case in the corresponding manner also for the lower clamp ring 30, at the separation site 31 there is a positive locking device 35 which has locking bodies 37 which can be caused to engage one another by interlocking, these latter being shaped such that a snap connection arises in the locked state.

FIGS. 8 and 9 show a modified example of the lower clamp ring 30. The latter, as is also the case for the upper clamp ring, is analogously designed for cementing of the end edge 9 from FIG. 5 of the jacket 7, when the end edge 9 has been inserted into the inner annular groove 39 of the clamp ring 30. The corresponding is also provided in this way for the other clamp ring. This exemplary embodiment from FIG. 8 also differs from FIGS. 5 to 7 in that at the separation site 31 there is positive interlocking of the ring ends, the engagement by interlocking taking place by insertion of an interlocking body 41 on one ring end into a recess 43 on the other ring end, which insertion takes place in the peripheral direction of the ring.

It goes without saying that instead of the above described configuration of the fixing device for the trap jacket 7 with fixing elements 27 and 29 which are formed by elastic clamp rings 30, various other designs are possible. Instead of using the clamp rings 30, it would be possible to proceed such that the end edges 9 of the trap jacket 9 are placed around the peripheral surfaces of the cover parts 11 and are held there by means of a ring of elastomer material, for example a rubber band ring.

Furthermore, instead of the above shown jacket closure 25 in the form of a touch fastener strip placed over the joint of the web of filter material, it would also be possible to proceed such that the web of filter material is dimensioned such that the ends overlap when the web of filter material has been placed around the filter element 1, in the overlapping region a touch fastener with internal interlocking being formed.

An alternative connecting technique is to produce a cylindrical nonwoven body with overlapping which is bonded on the ends, which is pulled coaxially onto the perforated outer jacket and with the latter in turn rests loosely in the region of the open ends or is tightly bonded.

1. A filter device for fluids, particularly hydraulic fluids, lubricating oils, or fuels, with at least one filter element (1) which has an inflow region (5) for the fluid to be cleaned, characterized in that an adapter element (7) which covers the inflow region (5) and which forms a trap device for organic substances such as grease particles and/or incompletely dissolved organic substances can be attached to the filter element (1).

2. The filter device according to claim 1, characterized in that the filter element (1) is a body which defines a longitudinal axis (3) and whose outer surface (5) which surrounds the longitudinal axis (3) forms the inflow region, and that the adapter element has the shape of a trap jacket (7) which covers this outer surface (5).

3. The filter device according to claim 2, characterized in that the jacket (7) is formed from a web (21) of filter material whose opposite ends can be brought together to form the jacket shape and can be connected to one another via a jacket closure (25) which runs in the longitudinal direction.

4. The filter device according to claim 2, characterized in that the outer surface (5) of the filter element (1) is circularly cylindrical and the trap jacket (7) has the shape of a hollow cylinder.

5. The filter device according to claim 3, characterized in that the jacket closure (25) is formed by an adhesive connection.

6. The filter device according to claim 1, characterized in that there is a nonwoven (21) with a coarse pore structure for forming the trap device.

7. The filter device according to claim 6, characterized in that the nonwoven (21) is of lipophilic material, in particular fibers of polyolefin or polyester with co-polyesters or other nonpolar organic materials.

8. The filter device according to claim 7, characterized in that the web of filter material formed from the nonwoven (21) has a cross-linked, voluminous fiber structure with coarser fineness than that of the downstream filter element.

9. The filter device according to claim 2, characterized in that on the filter element (1) on each of its ends which are opposite one another in the longitudinal direction there is a cover element (11) which forms the ends of the inflow region (5) and that there is a fixing device (27, 29) to fix the pertinent end edge (9) of the trap jacket (7) on the cover elements (11).

10. An adapter element intended for a filter device according to claim 1, with a coarse-pored nonwoven (21) which can be attached to the assigned filter element (1) as a prefilter stage which covers its inflow region (5).

11. The adapter element according to claim 10, characterized in that there is a lipophilic nonwoven (21) with a cross-linked and voluminous fiber structure, in particular of polyolefin or polyester with co-polyesters or other nonpolar organic materials.

12. The adapter element according to claim 10, characterized in that the nonwoven (21) forms a web of filter material whose opposite ends can be brought together to form a hollow cylindrical jacket (7) and can be connected by a closure means (25).

13. The adapter element according to claim 12, characterized in that the closure means (25) has an adhesive closure.
